(19) United States
(12) Patent Application Publication
(10) Pub. No.: US 2006/0104385 A1
(43) Pub. Date: May 18, 2006

(54) Systems with increased information rates using embedded sample modulation and predistortion equalization implemented on metallic lines

(76) Inventor: Edmunde E. Newhall, Calgary (CA)

Correspondence Address: EDMUNDE E NEWHALL, Suite 2601, 1200 6th St. S.W, Calgary, AB, T2R 1H3, CA

(21) Appl. No.: 10/986,940

(22) Filed: Nov. 15, 2004

(51) Int. Cl. H04L 27/22; H04B 1/10

(52) U.S. Cl. 375/316; 375/350

(57) ABSTRACT

In these systems overlapping symbols are transmitted in one symbol time. The basic symbol, termed a half dipulse, is shaped so that a subset of samples, termed the embedded samples, has an inverse. This inverse is used at the receiver to remove the intersymbol interference amongst overlapping symbols. A symbol made up of a half dipulse and a shifted, inverted half dipulse is referred to as an ideal dipulse. Predistortion equalization is accomplished by first transmitting this dipulse over the channel, recording the result and determining the shape of a distorted dipulse, termed the predistorted composing function, when applied at the transmitter will produce a dipulse at the receiver, referred to as the response dipulse, as close as possible to an ideal dipulse. Subsequent transmitted waves are made up of the sum of overlapping, scaled values of the predistorted composing function, the scaling determined by the modulation to be transmitted. The received wave is thus made up of the sum of scaled overlapping response dipulses. A receiver is described which operates on this received wave to produce a first estimate of the transmitted modulation. This first estimate is corrected by generating a local wave, based in this first estimate, and differencing it with the received wave. From this difference wave, errors in the first estimate are located and corrected.

The use of embedded sample modulation and predistortion equalization in passband and baseband systems has been described; see SYSTEMS WITH INCREASED INFORMATION RATES USING EMBEDDED SAMPLE MODULATION AND PREDISTORTION EQUALIZATION by Edmunde Newhall; U.S. Pat. No. 5,448,206; European patent EP 0 707 767 B1 filed in Germany, France, England; Canadian patent 2,160,978.

In these systems overlapping symbols are transmitted in one symbol time. The basic symbol, termed a half dipulse, is shaped so that a subset of samples taken from the symbol has an inverse. This provides a method for removing the intersymbol interference between overlapping symbols. A symbol made up of a half dipulse and an inverted and shifted half dipulse is referred to as an ideal dipulse. Predistortion equalization is accomplished by transmitting this dipulse over the line, recording the response and determining the shape of a distorted dipulse, termed the predistorted composing function, when applied at the transmitter will produce a dipulse at the receiver, refered to as the response dipulse, which is as close as possible to an ideal dipulse. Subsequent transmitted waves are made up of the sum of overlapping, scaled values of the predistorted composing function, the scaling determined by the modulation to be transmitted. Thus the received wave is made up of the sum of scaled overlapping response dipulses and can be processed to recover the transmitted data, this processing described herein.

A method for achieving sampling at the peak of the of the response dipulse, termed synchronized sampling, is described. A method for filtering the response dipulses to closer approximate ideal dipulses is described. A method for adjusting the inverse filter is described, to adjust for the remaining distortion after filtering of the response dipulses. A method for correcting errors in the first estimate of the transmitted modulation is described, which compares the received baseband wave with a locally generated wave, generated from the first estimate of the transmitted modulation. The system realized is a practical implementation of the above referenced patent.

The above referenced patent describes an iterative method for constructing the inverse filter. A one step method of inverse calculation is described here. In the implementation described here the number of terms in the inverse is reduced significantly to a practical level of thirteen.

The invention can be further described with reference to the following drawings.

### DESCRIPTION OF THE DRAWINGS

FIG. 1A Half Dipulse.

FIG. 1B Embedded Samples.

FIG. 1C Inverse Filter.

FIG. 1D Embedded Samples filtered by Inverse Filter.

FIG. 1E DIP9.

FIG. 1F Embedded Samples from DIP9.

FIG. 1G DIP9 Embedded Samples filtered by Inverse Filter of FIG. 1C.

FIG. 2A Transmitted Modulation and associated Input Levels.

FIG. 2B Transmitted Waveshape associated with the Modulation of FIG. 2A.

FIG. 2C Embedded Samples extracted from FIG. 2B.

FIG. 2D Embedded Samples filtered by Inverse Filter of FIG. 1C.

FIG. 3A Predistorted Composing Function.

FIG. 3B Power Spectrum of DIP9.

FIG. 3C Transmission Line Representation.

FIG. 3D Real and Imaginary parts of V0/VI.

FIG. 3E Power Spectrum of V0/VI.

FIG. 3F Transmission Line response to Predistorted Composing Function.

FIG. 4A Transmitted Wave: Ideal Dipulse Composing Function.

FIG. 4B Transmitted Wave: Predistorted Dipulse Composing Function.

FIG. 4C Received Wave after transmission through line of FIG. 3C.

FIG. 5A Embedded Samples from the Received Wave of FIG. 4C.

FIG. 5B Recovered Samples: Transmitted Modulation.

FIG. 5C Predistorted Composing Function for 5000 ft 19 gauge: 100 Khz.

FIG. 5D Predistorted Composing Function for 10000 ft 19 gauge: 25 Khz.

FIG. 6A Predistorted Composing Function determined from Transmission Line measurement.

FIG. 6B Sample Synchronization.

FIG. 6C Transversal Filter.

FIG. 6D Filtered Response Dipulse.

FIG. 6E Modified Inverse.

FIG. 6F Embedded Samples of FIG. 6D filtered by Modified Inverse.

FIG. 7A Data Portion of a Typical Received Wave.

FIG. 7B Output from Modified Inverse.

FIG. 7C Difference between Received Wave and Locally Generated Wave.

FIG. 7D Estimate of Base Line Wander.

FIG. 7E Difference with Base Line Wander removed.

FIG. 8A Difference with Error.

FIG. 8B Processed Difference wave with samples 7,8,9,10,11 added.

FIG. 8C Processed Difference wave with samples 8,9,10,11,12 added.

FIG. 8D Processed Difference wave with samples 9,10,11,12,13 added.

FIG. 9A Typical Difference Waveshape.

FIG. 9B Analytically Generated Offset Correction.

FIG. 9C Difference Wave with Offset Correction removed.

FIG. 9D Predistorted Composing Function with one quarter the sample spacing.

FIG. 9E Values for Half Dipulse shown in FIG. 1A.

FIG. 10A Power Spectrum of DFT of samples in EMB(z).

FIG. 10B Typical Line response.

FIG. 10C Power Spectrum of Line response.

FIG. 10D DIP9.

FIG. 10E Power Spectrum of DIP9.

FIG. 11A Complex pair associated with Response Transversal Filter.

FIG. 11B Response Transversal Filter before Truncation.

FIG. 11C Response Dipulse filtered by Response Transversal Filter.

FIG. 11D Comparison of DFT of ideal dipulse and DFT of dipulse of FIG. 11C.

FIG. 12A Predistorted Composing Function applied to experimental system.

FIG. 12B Response dipulse.

FIG. 12C Power Spectrum of response dipulse.

FIG. 12D DFT of ideal dipulse divided by DFT of Response dipulse

FIG. 12E Presdistorted Composing Function Transversal Filter.

FIG. 12F Adjusted Predistorted Composing Function.

FIG. 12G Response to Adjusted Predistorted Composing Function.

FIG. 13A Typical Response Dipulse after filtering by Response Dipulse Transversal Filter

FIG. 13B Embedded samples from FIG. 13A.

FIG. 13C Embedded samples of FIG. 13B filtered by inverse filter of FIG. 1C

FIG. 13D DFT of Ideal Double Impulse of FIG. 1G.

FIG. 13E DFT of Ideal Double Impulse divided by DFT of FIG. 13C.

FIG. 14A Transversal filter associated with the DFT of FIG. 13E

FIG. 14B Modified Inverse Filter.

FIG. 14C Modified Inverse Filter convolved with embedded samples of FIG. 13B

### BASIC ELEMENTS

A dipulse is a positive pulse followed by an equal area negative pulse. The positive pulse only will be referred to as a half dipulse.

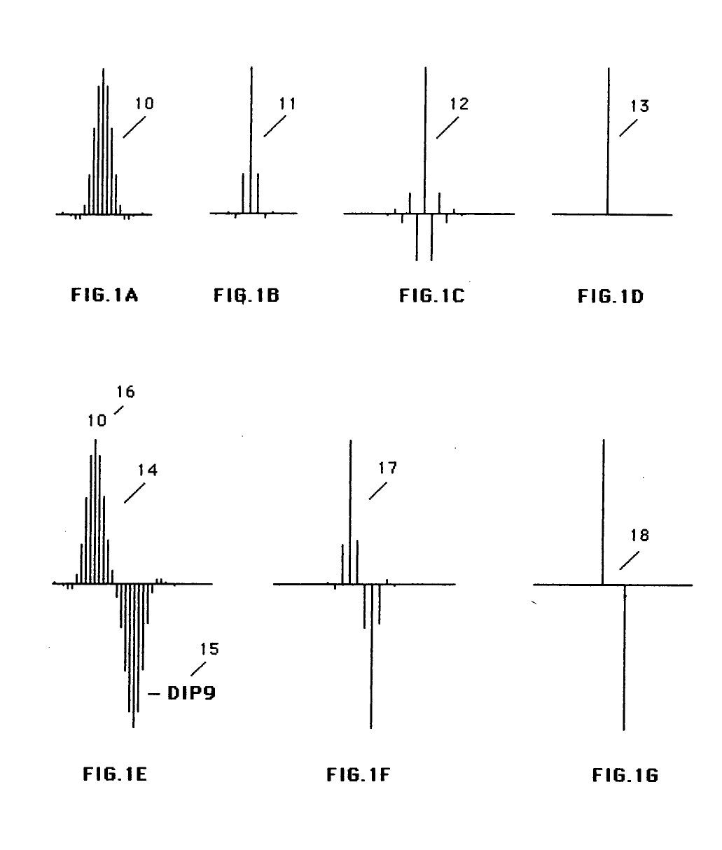

A half dipulse 10 is shown in FIG. 1A. The samples in this half dipulse were established starting with a raised cosine (see Proakis: Digital Communications). The real and complex roots of the Z transform of a raised cosine were determined and these roots were moved off the unit circle in the Z plane (see above referenced patent for more detail). The repositioned roots were then recombined to establish a modified Z transform. The sample values of the half dipulse 10 were set equal to the coefficients of this modified Z transform.

Whenever a function H(z) has no roots on the unit circle then the inverse function 1/H(Z) exists and the product of H(z) and the inverse is a unit pulse. It turns out that subsets of the samples in H(z) also have an inverse.

Consider extracting every third pulse from the half dipulse 10 of FIG. 1A. The result is shown in FIG. 1B. These are termed the embedded samples 11. In practice the half dipulse of FIG. 1A is transmitted and acts as a carrier for the embedded samples which are extracted to recover the transmitted information.

The transmitted information is recovered by passing the embedded samples through an inverse filter. The inverse filter 12 for these embedded samples is shown in FIG. 1C. When the embedded samples 11 of FIG. 1B are convolved with the inverse filter 12 of FIG. 1C the output is the impulse 13 of FIG. 1D. The amplitude of the impulse depends on the amplitude of the half dipulse which was transmitted.

FIG. 1E shows an ideal dipulse 14 made up of an half dipulse and a shifted half dipulse reversed in sign. The shift is 9 time intervals hence the name DIP9 15. The peak 16 is the tenth sample of this ideal dipulse. The spectrum of DIP9 does not have a DC component so will pass through the transformers and capacitors in communication systems, albeit with distortion, but with no unwanted trailing transient which a half dipulse could generate. Consider extracting every third sample from DIP9. These are the embedded samples associated with DIP9. These embedded samples 17 are shown in FIG. 1F. FIG. 1G shows the result when embedded samples 17 are filtered by the inverse filter 12 of FIG. 1C. The output is the double impulse 18.

### Modulation

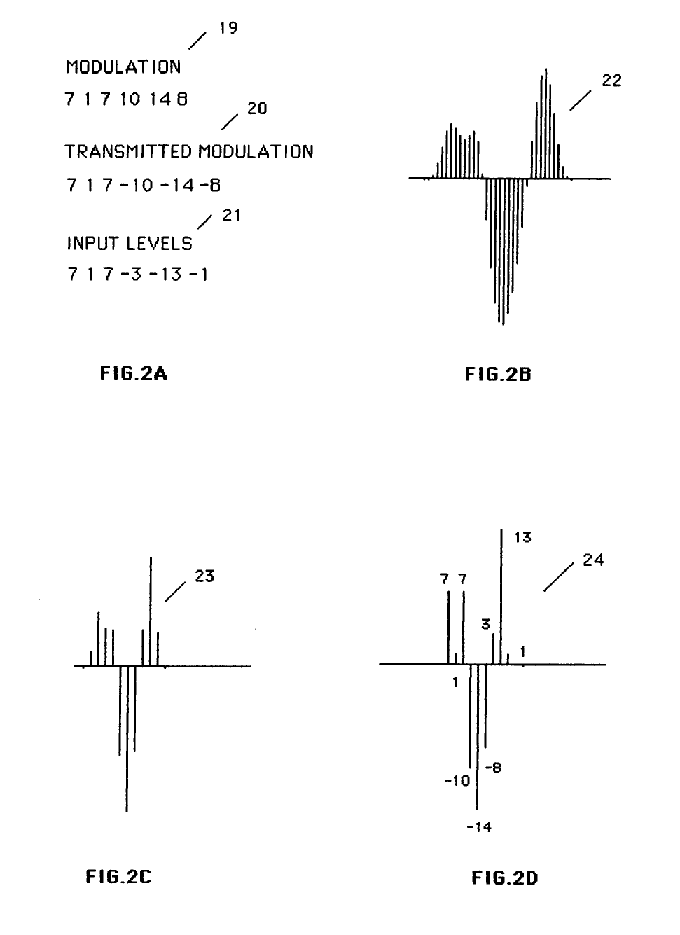

Consider sending 16 levels each of the levels representing 4 bits. Suppose the random modulation levels 19 shown in FIG. 2A are to be transmitted. The first three random levels 7,1,7 are transmitted as positive signals and the next three as negative signals, the next three positive and so forth. The transmitted modulation 20 is shown in FIG. 2A.

The transmitted wave is made up of scaled predistorted composing functions whose scaling is determined by the modulation to be transmitted. A predistorted composing function when transmitted over the channel arrives at the receiver as a dipulse, hereafter referred to as the response dipulse, very similiar by not identical to ideal dipulse 14 of FIG. 1E. Input of a scaled predistorted composing function of amplitude 7 will be referred to as a level 7 input. A level 7 input would be used to transmit the first modulation level of the transmitted modulation 20 of FIG. 2A. It is convenient to think of the arriving dipulse as made up a half dipulse of amplitude 7 starting at time position 1 and another half dipulse of amplitude −7, hereafter referred to as the bias, arriving at time position 10. This follows since the half dipulses making up a DIP9 are shifted 9 time positions. A level 1 input, transmitted 3 sample times later, will deliver a half dipulse of amplitude 1 at time position 4, which represents properly the second modulation level to be transmitted and introduces a bias of −1 at time position 13. A level 7 input, transmitted 3 sample times later, will deliver a half dipulse amplitude of 7 at time position 7, which repesents properly the third modulation level to be transmitted and introduces a bias of −7 at time position 16. At time position 10 the modulation to be transmitted is −10, there is already a bias (a half dip) of −7, so at this time an input of −3 is transmitted, which results in a level of −10 at time position 10, which represents the modulation properly, and a bias of 3 at time position 19. At time position 13 an input level of −13 will deliver the required modulation level and a bias at time position 22 of 13. At time position 16 an input level of −1 will deliver the required modulation level and a bias at time position 25 of 1. The transmitted modulation 20, and the associated input levels 21 are shown in FIG. 2A.

The received wave 22 is shown in FIG. 2B. This wave is made up of the sum of scaled response dipulses. In practice a filter would be applied whose output would be closer to the sum of scaled ideal dipulses. Assuming this filter has been applied the modulation is recovered by first extracting every third sample of the received wave 22 of FIG. 2B. FIG. 2C shows these embedded samples 23. When these embedded samples are convolved with inverse filter 12 of FIG. 1C the output is the recovered modulation 24 of FIG. 2D. The modulation 19 of FIG. 2A is recovered. The trailing levels of 3,13,1 are associated with the bias introduced when input levels −3,−13,−1 were transmitted.

The input levels 21 in FIG. 2A all have an amplitude less than 16, however it can occur that an amplitude of 16 or greater is required. If for example the modulation level to be transmitted is 15 and bias at this time position is −2, a level of 17 would be required. In this case the sign of the modulation is reversed, in this case to −15. The level to be transmitted is then −13.

### Predistorted Composing Function Determination

To determine this function from line measurement a DIP9 of the form shown in FIG. 1E is transmitted over the line and the response compared to the desired response which is a DIP9. The transmitted wave is modified and the process repeated until the arriving dipulse approximates a DIP9. The transmitted wave is referred to as the predistorted composing function.

In terms of Z transforms let the input to the line be represented by X(z), the line by H(z) and the response by Y(z) then:
X(z)H(z)=Y(z)
Determine a function C(z) such that C(z)Y(z)=DIP9(z) where DIP9(z) is the Z tranform of the samples in DIP9. Then:
C(z)Y(z)=DIP9(z) C(z)=DIP9(z)/Y(z)
Determine C(z) from the C(z)=DIP(z)/Y(z). Multiply the above by C(z) to obtain:
C(z)X(z)H(z)=C(z)Y(z)=DIP9(z)
Thus if C(z) is convolved with X(z) and the result applied to the line the expected output will be the desired response DIP9(z). Thus C(z) convolved with X(z) is a first estimate of the predistorted composing function. The estimate is improved by repeating the process.

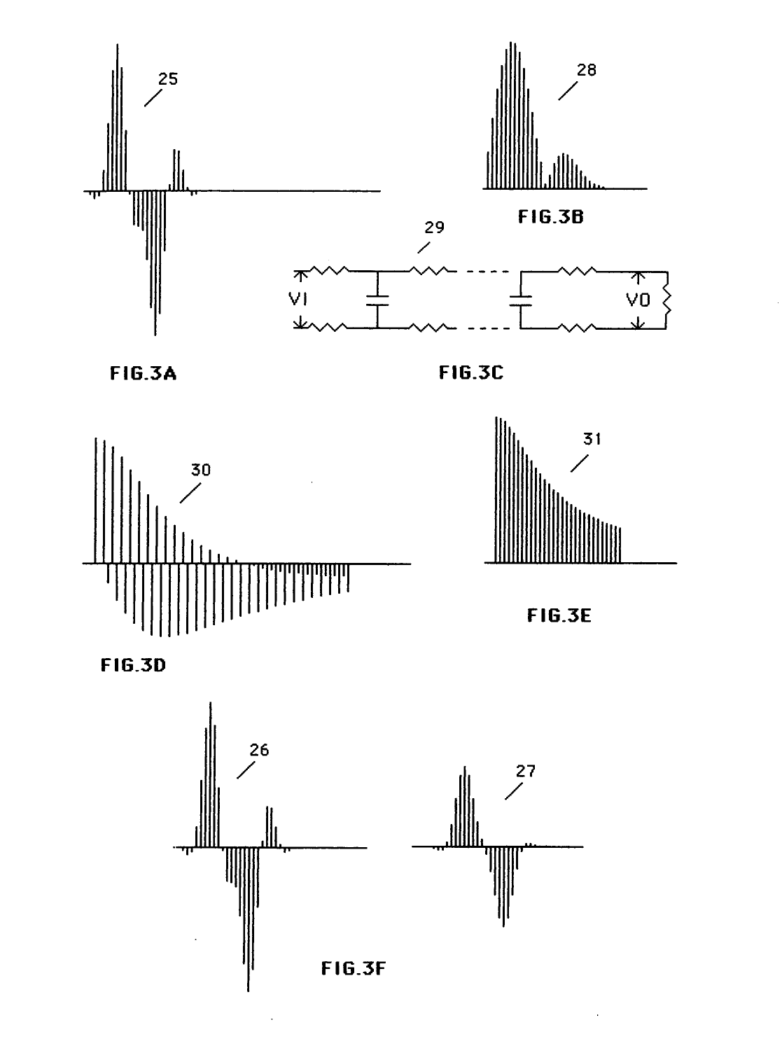

The operations outlined above are performed here using Discrete Fourier Transforms (DFT) and Inverse Discrete Fourier Transforms (IDFT). The DFT of the samples in C(z) are found by dividing the DFT of the samples in DIP9(z) by the DFT of the samples in Y(z). The DFT of the samples in C(z) is then multiplied by the DFT of the samples in X(z). The IDFT of this result is then taken to determine the samples in the predistorted composing function. A typical predistorted composing function 25 is shown in FIG. 3A. In this case this is the waveform which when transmitted through a line simulating 10,000 ft of 26 gauge twisted copper pair arrives undistorted at the receiver. The input 26 and response 27 are shown in FIG. 3F. Relative size of input and output have been maintained in the diagram.

This response was determined analytically by first finding the DFT of DIP9 then the Power Spectrum 28, which is shown on FIG. 3B. The Power Spectrum associated with a DFT is the square root of the sum of the square of the real part and square of the imaginary part.

There are 29 significant frequencies in this Power Spectrum. In this example the frequency of the DIP9 of FIG. 1E was set to 3 Khz. There are 9 time intervals between positive and negative peak so 18 time intervals in a cycle. The duration of a cycle is then ( 1/3000) seconds and the time Δt, between samples 1/(3000*18).

The DFT coefficients of a finite duration sequence are a unique representation of the sequence because the IDFT may be used to reconstruct the sequence exactly. In practice the DFT and IDFT are implemented using Fast Fourier Transforms (fft). In this case fft128 was used. Thus any sequence of 128 samples can be represented exactly by 128 frequency pair. In this case Δt*Δf= 1/128. Since Δt is known Δf is known and the set of 128 frequencies used in the DFT are known. fft128 was used in determining the Power Spectrum 28 shown in FIG. 3B, so the frequencies are known. The response of the line was evaluated at this same set of frequencies.

The frequency response of 10,000 ft of 26 gauge line was determinded by dividing the line 29 into a number of resistor capacitor segments as shown in FIG. 3C. For each frequency, in the set of 29 frequencies, the admittances and impedances were combined to determine the relative size and phase of VO and VI. These results are shown in FIG. 3D, where the real and imaginary components of 29 pair are plotted, for each pair the real part first followed by the imaginary part. The set of 29 pair in FIG. 3D are the first 29 pair in the DFT of the line impulse response. The associated Power Spectrum 31 is shown in FIG. 3E. The 29 pair of FIG. 3D will be referenced as the line frequency response 30.

If the Z transform of the predistorted composing function is represented by P(z) and the line impulse response by H(z) then P(z)H(z)=DIP9(z): P(z)=DIP9(z)/H(z). In terms of discrete fourier transforms the DFT of P(z) is determined by dividing the DFT of DIP9(z) by the DFT of H(z) both of which are known to 29 frequency pair. The IDFT of this result is the desired predistorted composing function 25 of FIG. 3A.

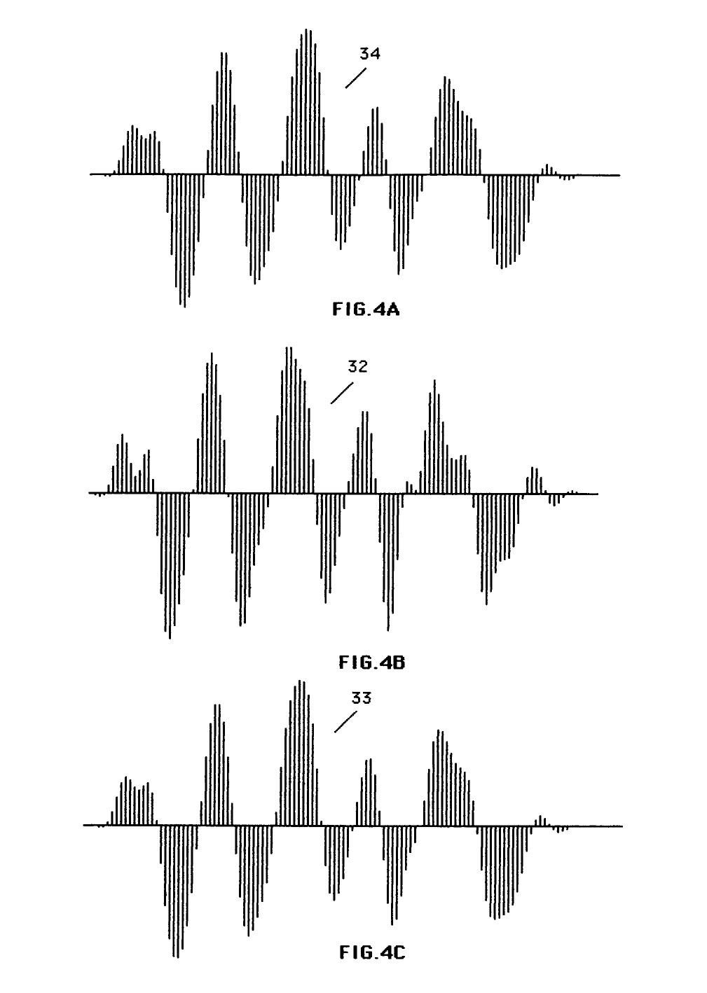

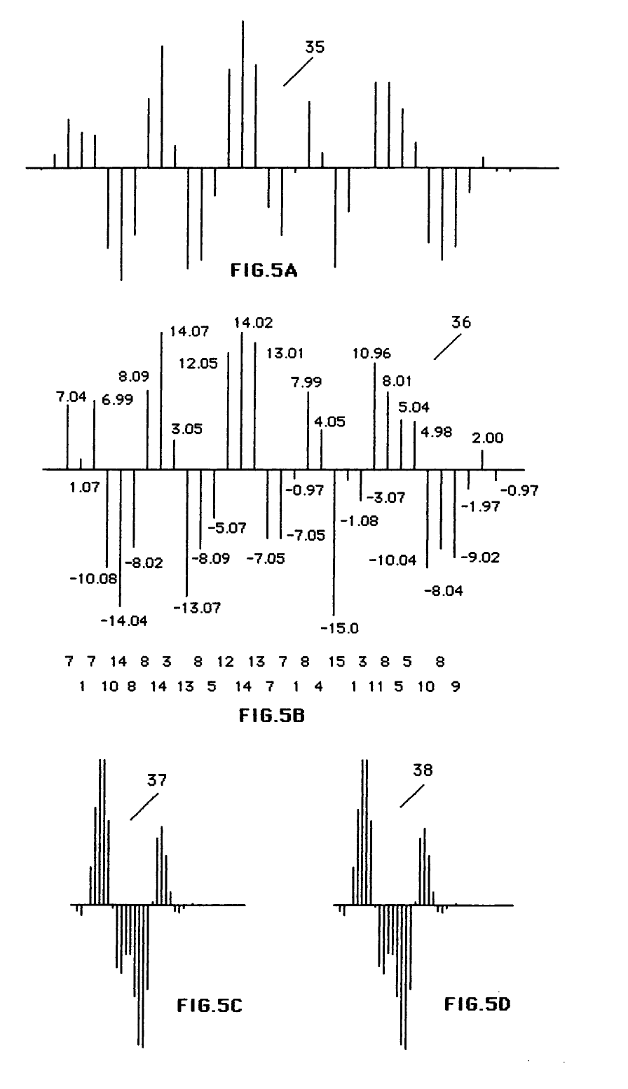

In practice the transmitted wave is made up of scaled predistorted composing functions, the scaling determined by the modulation to be transmitted. The predistorted composing function 25 of FIG. 3A was used to generate the transmitted wave 32 of FIG. 4B. When this wave is passed through the line whose line frequency response 30 is shown in FIG. 3D the output wave should be the sum of scaled ideal dipulses from which the modulation can be recovered. The wave 32 shown in FIG. 4B has less than 128 samples so can be represented exactly if fft128 is used. The affect of the channel on the wave can be determined by taking the DFT of wave 32 and multiplying by the line frequency response 30 shown in FIG. 3D and taking the IDFT. The line response 33 is shown in FIG. 4C. The wave 34 of FIG. 4A was generated using an ideal dipulse as a composing function and the same modulation as used in FIG. 4B. When FIG. 4A and FIG. 4C are compared they appear to be remarkably similiar it should be possible to recover the modulation be extracting the embedded samples in FIG. 4C and pass them through the inverse filter. The embedded samples 35 are shown in FIG. 5A. The recovered sample levels 36, which result when these these embedded samples are filtered by the inverse filter 12 of FIG. 1C are shown in FIG. 5B. The transmitted modulation levels are also shown. A quantizer applied to this set of samples would have a range of +−0.5 i.e the first sample would be treated as level 7 if its value is between 6.5 and 7.5.

It is clear that if this quantizer were applied the transmitted modulation would be recovered without error.

In the wave of FIG. 4C in one cycle there are three overlapping positive dips with 16 levels each (12 bits) followed by 3 overlapping negative levels with 16 levels each giving 24 bits/hertz. Let Δt be the time between samples in DIP9. A new dipulse is introduced every 3Δt so the period of the positive and negative overlapping dipulses is 18Δt which is the same as the period of the DIP9 composing function. In this case the fundamental frequency of the DIP9 composing function is 3 Khz so the number of bits/sec is 72 kbits/sec.

### Scaling of the Results

FIG. 5C shows a predistorted composing function 37 for 5000 ft of 19 gauge for a DIP9 with a frequency of 100 Khz. That is to say that when the predistorted composing function 37 is applied to a line simulating 5000 ft of 19 gauge the output DIP9 will have a frequency of 100 Khz.

Waveshape 38 of FIG. 5D is the predistorted composing function for 10000 ft of 19 gauge for a DIP9 with a frequency of 25 Khz. Waveshapes 37 and 38 are identical. This implies that as the line length is halved the transmission rate which can be realized, using the same shape of predt, will be is multiplied by four. The relative size of predistorted composing function and response will be maintained. This result is not unexpected as when the line length is halved the total resistance is halved and the total capacitance is halved. This result also implies that the same predistorted composing function can be used on a line of length of 2500 ft at 400 Khz, 1250 ft at 1600 Khz etc.

In the above example, 16 levels were used which achieved 24 bits/hertz. If 4 levels are used the three overlapping half dips in the positive half cycle will deliver 6 bits and the three overlapping half dips in the negative half cycle 6 bits giving 12 bits/hertz. If 8 levels are used 18 bits per hertz will be realized.

DIP9 was generated from a half dipulse by shifting the half dipulse 9 time intervals. The inverse filter will stay the same but the predistorted composing function will change if the shift is 12 time intervals generating a DIP12. In this case 4 positive levels will be transmitted followed by 4 negative levels. In this case with 4 levels 16 bits/hertz will be realized and with 8 levels 24 bits/hertz. Experiments were done using DIP9 but DIP12 could be used to implement a practical system.

### Experimental System

The system used to develop the receiver algorithms described here, used 4 levels and a DIP9 frequency of 12 Khz. This system was also used to; test methods for achieving synchronized sampling at startup; test methods for achieving synchronized sampling on long signals; test methods for line probing to determine the predistorted composing function; test methods for removing base line wander. These results are summarized below

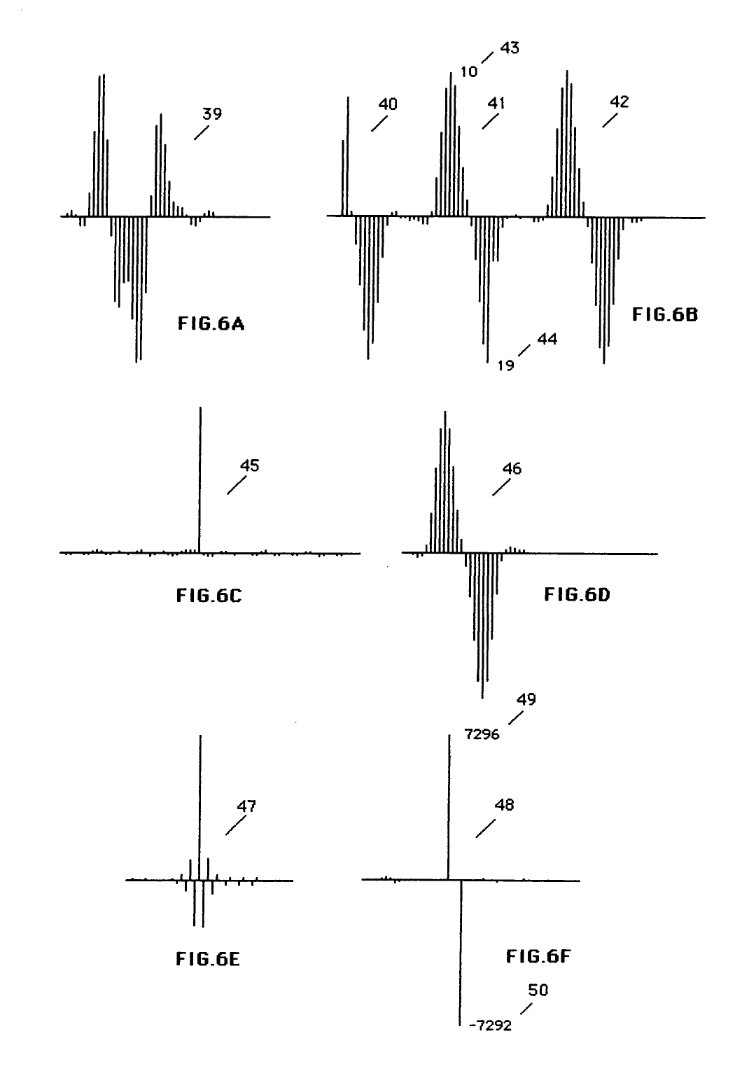

The measured predistorted composing function 39 shown in FIG. 6A, was determined using the method described above. A reverse channel was required to return the recorded response. A 1200 baud fsk channel was used for this purpose. At system startup, when no predistorted composing function had previously been recorded, 3 to 5 iterations were required to establish this function.

Using the predistorted composing function 39, three dipulses are sent, the first two are used to achieve synchronized sampling. The third is the response dipulse. The associated DSP (Digital Signal Processor) determines a transversal filter which when used to filter the response dipulse will generate a dipulse which is a better approximation to an ideal dipulse, applies the transversal filter to the response dipulse to generate the better approximation to an ideal dipulse and extracts the embedded samples. The DSP then generates a modified inverse filter from these embedded samples.

FIG. 6B shows three dipulses, 40,41,42 from an operating system. Only part of the first dipulse 40 is shown. The 10th sample of this dipulse is the peak. The 9th and 11th samples are differenced and the difference compared with an ideal DIP9 and the sample point shifted appropriately. The A/D convertor is driven from a counted down crystal which allows insertion or deletion in the count down chain. In this case the sample point can be shifted 1/54 of Δt, where Δt is the time between samples. Interrupts are turned off while the sample point adjustment is being made, so a portion of the first dipulse 40 was not captured. A fine tuning of the sampling point is done by summing the samples from the 10th 43 to the 19th 44 inclusive in the second dipulse 41, comparing with an ideal DIP9 and shifting the sample point appropriately. This second adjustment is usually small. Again the interrupts were turned off during sample point adjustment so several samples were lost just after the negative peak of the second dipulse. In the third dipulse 42, the response dipulse, the difference between the 11th and 9th sample is added to the difference between the 12th and 13th. This is referred to as the SKEW. A transversal filter is to be applied to this dipulse and when the system is started again, after the transversal filter has been determined, it is important to shift the sample point so that the transversal filter operates on an appropriate set of samples. The response dipulse 42 is captured, the SKEW recorded and the transversal filter 45 of FIG. 6C generated. Dipulse 46 of FIG. 6D is the output generated by filtering the response dipulse 42 with the transversal filter 45. The embedded samples of dipulse 46 are extracted and passed through inverse filter 12 of FIG. 1C. The ideal output would be double impulse 18 of FIG. 1G. Typically the double impulse at this point does not have equal positive an negative impulse amplitudes. A filter is determined which is convolved with inverse filter 12 to generate modified inverse 47. Modified inverse 47 when applied to the embedded samples in dipulse 46 generated double impulse 48. The positive level 49 and negative level 50, which are integer outputs from the DSP, are substantially the same. Transversal filter 45 and modified inverse 47 are moved to external FPGA (Field Programmable Gate Arrays). At this point the system is ready to process long signals.

To process long signals the sample synchronization process described above is repeated and when the response dipulse 42 of FIG. 6B is reached, the SKEW is measured, the recorded SKEW referenced and an appropriate sampling point shift is applied. Dipulse 40 and 41 of FIG. 6B are used when the transversal filter and modified inverse are to be determined and when the system is started to process long signals. They are not present subsequently. The SKEW is measured on both these occassions. A dipulse termed the SKEW dipulse is inserted at the end of a long data block to adjust the sampling point and maintain synchronized sampling.

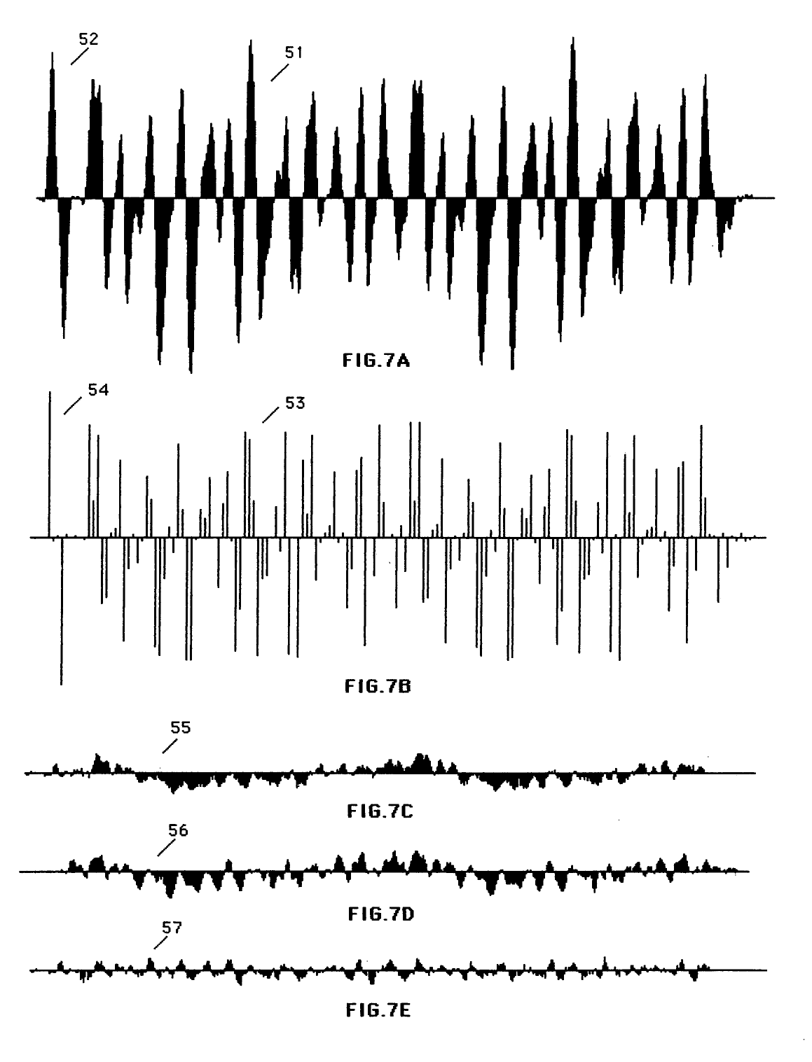

The data portion of a typical received wave 51, recorded from the experimental system is shown in FIG. 7A. Each data packet is preceded by an amplitude reference dipulse 52. The receiver processes the samples in the received wave in two different ways. To recover the transmitted modulation the samples, including the amplitude reference 52 are filtered by the transversal filter 45 of FIG. 6C, embedded samples extracted, the embedded samples passed through modified inverse filter 47 of FIG. 6E, and the resultant samples quantized. The result of these operations, up to but not including quantization, captured from the experimental system are shown as 53 in FIG. 7B. Processing of amplitude reference 52 yields a double impulse 54. The value of the positive peak of this double impulse is fed to the quantizer to establish the reference level of 4 in this four level system. In this case there were no errors in the recovered modulation.

A second stream of samples is not processed by the transversal filter but differenced with a locally generated wave generated from the first estimate of the transmitted modulation. The difference is used to locate any error and error sign. If an error is present the system corrects the first estimate of the transmitted modulation, flushes the system of any samples in error. These operations are carried out in a separate FPGA. In getting this FPGA operating successfully a Pascal simulaton was carried out in parallel, whose operations mimiced as closely as possible the operations of the FPGA. The important results will be described by reference to the Pascal simulation and experimental system.

A number of received waves 51, with the same modulation, were captured from the experimental system and moved to the Pascal simulator. From each of these a locally generated wave with the same size of amplitude reference was subtracted. A typical difference 55 is shown in FIG. 7C. This suggests some base line wander in the received wave. Increasing the size of the coupling capacitors in the experimental system reduced this base line wander to the level shown in FIG. 7C. The base line wander signal 56 shown in FIG. 7D was chosen as representative value and subtracted from the base line wander of a number of received waves. A typical result, wave 57, is shown in FIG. 7E. This is the difference between the received wave and the locally generated wave with the base line wander removed. In this case, as in the case of wave 53 of FIG. 7B, there were no errors in the recovered modulation.

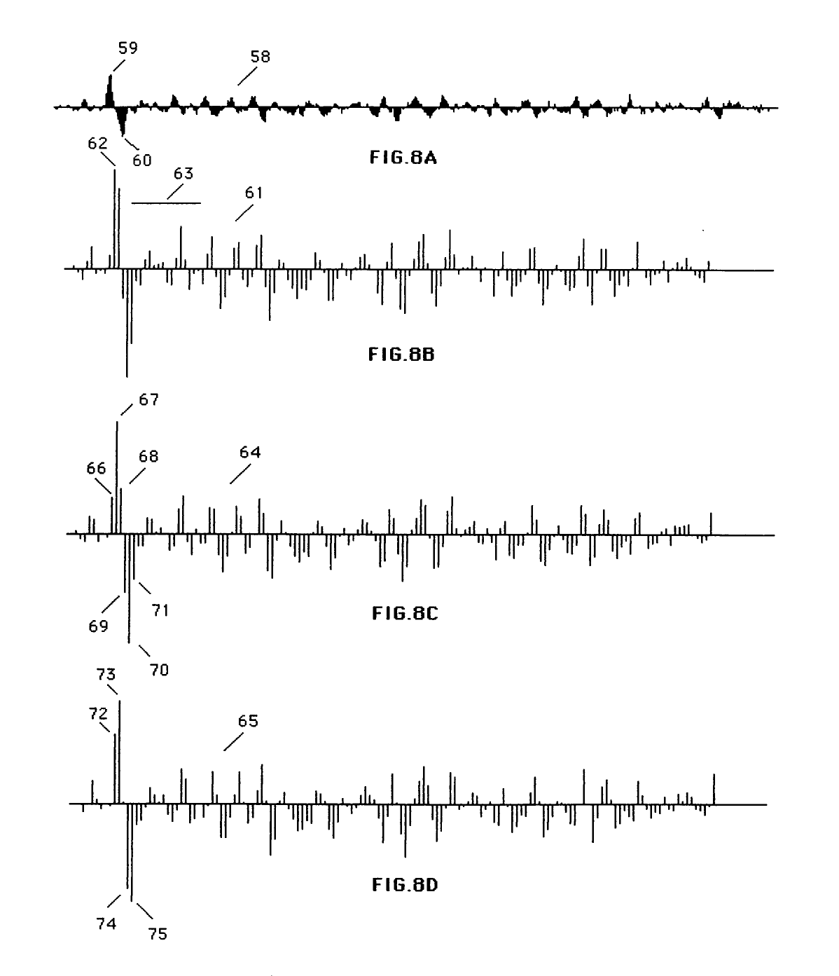

To evaluate the margins seen by the operating error correction system the Pascal simulation was used to introduce an error in a difference wave of type 57 by changing a modulation value used in the locally generated wave. The result is shown in FIG. 8A as wave 58. The pulse 59 indicates the presence of an error. Recall that when a DIP9 is transmitted in one time position a DIP9 of opposite polarity is transmitted in a later time position, hence the negative pulse 60. Some reflection shows that if two waves composed of DIP9 dipulses are subtracted the difference wave at the error position will have a DIP9 shape. In the error correction system implemented the system moves to a position one past where the peak of the error DIP9 could occur and adds samples 7,8,9,10,11 of the DIP9 (10 is peak) all of which are the same sign. If this sum exceeds a threshold the error is corrected. The position where these peaks can occur are separated by three sample intervals. Pascal was used to operate on waveform 58 of FIG. 8A by moving three sample positions, performing the addition operation described above, then moving three sample positions etc. This is the same operation performed in the experimental system. The result is shown in wave 61 of FIG. 8B. This shows that the experimental system will see the peak sample 62 in the wave 61, which is above the threshold 63 and operate to correct the error. Correcting the error at this point in time removes the negative pulse 60 in FIG. 8A. The margins are adequate for the four level experimental system but an improvement in margins is required for eight level systems.

Processing done in the experimental system does not take advantage of the negative peak 60.

The possible advantage of processing sample segments, rather than looking for a single threshold is shown in wave 64 of FIG. 8C and and wave 65 of FIG. 8D. The Pascal program was modified to proceed to points, separated by three samples, where an error could ocurr, and add samples around the peak, samples 8,9,10,11,12 for wave 64 and samples 9,10,11,12,13 for wave 65. For wave 64 the peak 67 occurs when the operation is performed to include the positive peak 59 and 70 when negative peak 60 is included.

If the pattern made up of samples 66,67,68,69,70,71 is searched for, by correlation for example, the margins would be substantially improved. In wave 65, the pattern made up of samples 72,73,74,75 could be used in the same manner. Processing the difference wave by adding a selected set of samples, e.g. samples 8,9,10,11,12, will be referred to as difference signal processing by selective addition. If a pattern established by selective addition is followed by a search for that pattern by correlation the difference signal processing will be referred to as difference signal processing by selective addition and correlation.

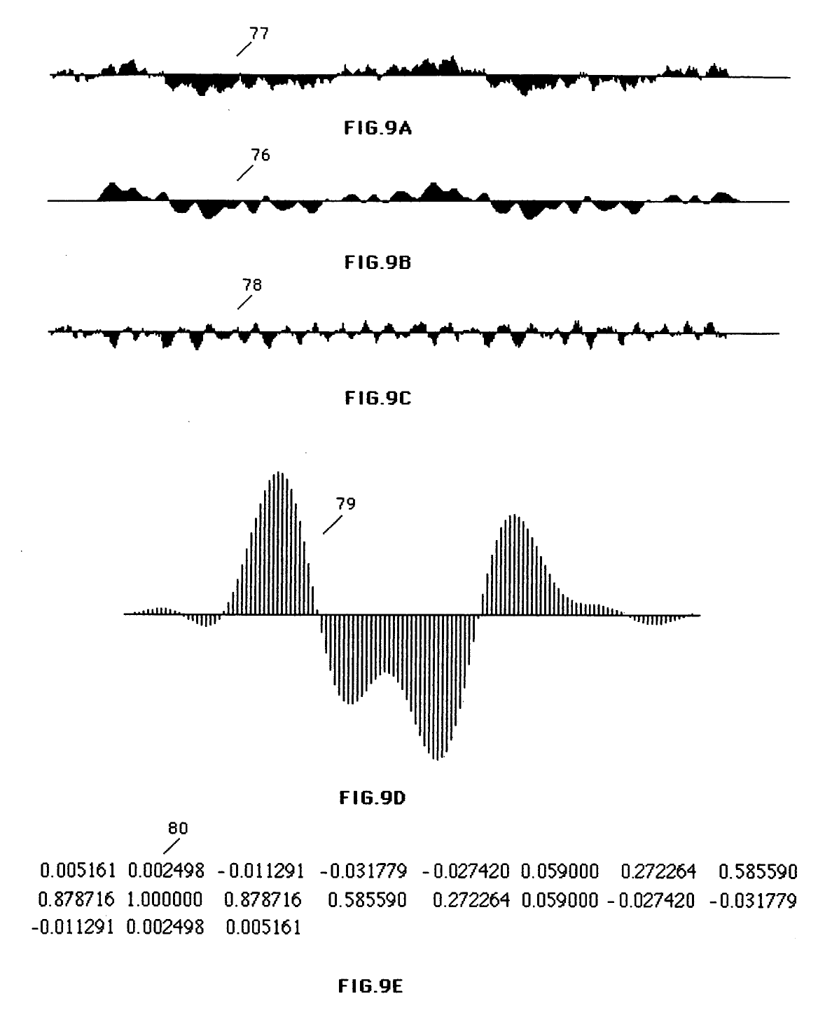

The offset correction 56 shown in FIG. 7D was deduced by repeating the transmission of wave 51 of FIG. 7A and out of the set of a difference waveshapes choosing wave 56 of FIG. 7D as a typical example. An analytical method of determining an offset correction waveshape follows if one considers integrating the samples in the locally generated wave. If the base line wander is caused by the charging of the coupling capacitors a little reflection shows that at a point in time the size of the offset will be related to the integral of the locally generated wave, or the received wave, preceding that point. The wave 51 of FIG. 7A was integrated from the beginning of the data portion, i.e. not including the amplitude reference. A fraction of the integrated wave is shown as wave 76 in FIG. 9B. This waves resembles the experimentally determined wave 56 of FIG. 7D. The wave 78 of FIG. 9C is the result when this analytically determined wave 76 of FIG. 9B is subtracted from the difference wave 77 of FIG. 9A. As expected the result is not unlike the difference wave 57 of FIG. 7E, which is the difference wave after base line wander correction. A straight integration does not allow for decay of the base line wander. In this integral model the base line wander caused by the positive pulse 52 of the amplitude reference will be offset by the negative pulse in the amplitude reference. A further examination shows that if the base line wander introduced by the positive pulse is 52 is allowed to decay then the difference wave 78 of FIG. 9C will be closer to wave 57 of FIG. 7E. Several other methods of removing base line wander suggest themselves. It is concluded that base line wander must be considered if more than 4 levels are to be successfully transmitted.

To realize more than four levels consider reducing the difference between the locally generated wave and the received wave. A predistorted composing function with more defining samples is a first step in this direction. If the DFT of the predistorted composing function 39 of FIG. 6A is taken and the IDFT taken with Δt=Δt/4 the predistorted composing function 79 of FIG. 9D is the result. The value of the original samples is maintained but the original samples are interpolated. The increased definition in this function could be used to reduce the difference between the response dipulse and an ideal dipulse, thereby reducing the size of the terms in the difference wave. Doubling the sampling rate at the receiver would further reduce the size of the samples in the difference wave. In this case the locally generated wave, used in generating the difference wave, would be the sum of scaled interpolated ideal dipulses, interpolated to double the number of samples in the ideal dipulse. In processing the difference wave, using selective addition, the number of samples added would be doubled. The recovered first estimate of the transmitted modulation could still be determined by using a subset of the samples received. In this subset every third sample would be an embedded sample and processing would proceed as above.

A predistorted composing function with more samples could be useful in another environment. In an earlier effort a half dipulse 10 of the same shape as shown in FIG. 1A with a small sample at the beginning and end was used. The 11th sample was the peak. A positive, scaled half dipulse was started at time positions 1,3,5,7,9 and negative dipulse at sample times 11,13,15,17,19. The lower half dipulse was shifted 10 time positions, this dipulse referred to as a DIP10. This would realize 20 bits/hertz if 4 levels were used and 30 bits/hertz if 8 levels were used. The difficulty is this case was an impractical number of samples in the inverse.

Experience has shown that the number of samples in the inverse is strongly dependent on the height of the peak sample relative to the height of the embedded sample next to the peak. The greater the difference the fewer the number of terms in the inverse. This requires a sharply peaked half dipulse, which can be created by moving the zeros of the Z transform of the half dipulse. The predistorted composing function which carries the embedded samples will likely require interpolation as above. These changes should bring about a practical implementaion of the DIP10 system above.

### Inverse Filter Determination

Consider the embedded samples 11 of FIG. 1B. Represent these samples by the Z transform EMB(z). The inverse 12 of these samples is shown in FIG. 1C. Represent these samples by INV(z). When the samples 11 are convolved with the inverse 12 the impulse 13 of FIG. 1D is the output. Represent the impulse 13 by IMP(z). In terms of Z transforms this can be expressed as:
EMB(z)INV(z)=IMP(z) or INV(z)=IMP(z)/EMB(z)
The operations implied are performed using Discrete Fourier Transforms. The DFT of the sample IMP(z) is determined and multiplied by the inverse of the DFT of the samples in EMB(z). The IDFT of this product produces the inverse 12 of FIG. 1C.

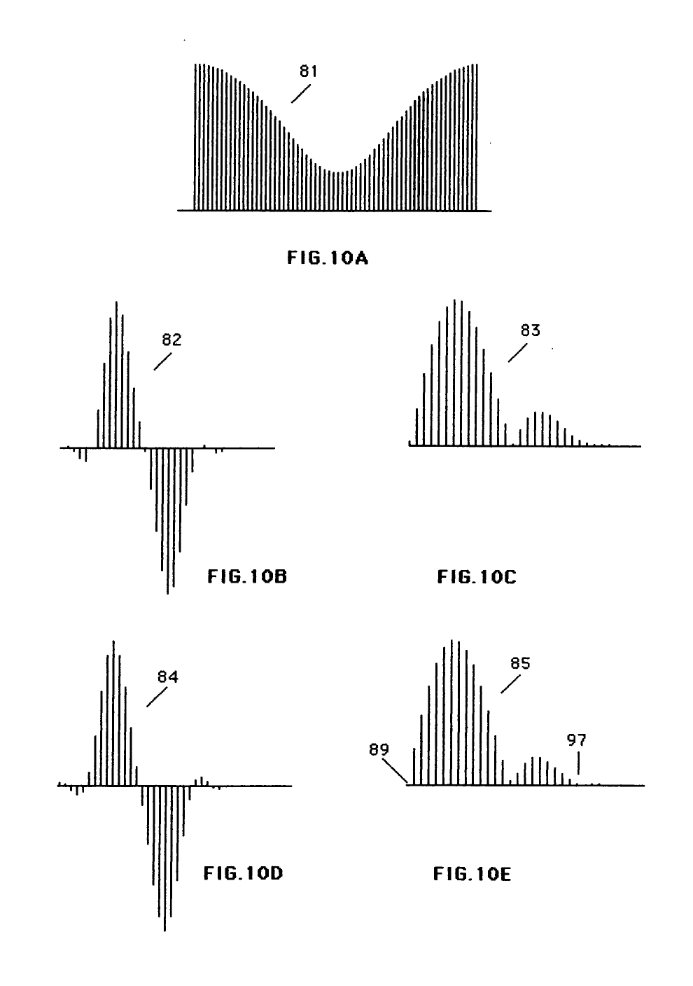

From Theory and Application of Digital Signal Processing by Rabiner and Gold the DFT is given by:

$${X}_{P} ( k ) = {\sum }_{n = 0}^{N - 1} {x}_{p} ( n ) {ⅇ}^{- j ( 2 π / N ) nk}$$

where xₚ(n) are the samples in a sample set with N samples and Xₚ(k) are N complex pair (DFT coefficients) associated with the N frequencies. In practice the DFT and IDFT are implemented using Fast Fourier Transforms (fft). N typically takes on powers of 2. In this case fft64 has been chosen so N in the above takes on the value 64. The value of the samples in the half dip 10 of FIG. 1A are shown as 80 in FIG. 9E. If every third sample is extracted the embedded samples 11 of FIG. 1B are obtained. If the above is applied to these samples the DFT of the samples in EMB(z) is obtained. Each sample is a complex pair and there are 64 pair. The Power Spectrum 81 of this DFT is shown in FIG. 10A. If a pair in this DFT is represented by x+iy then the inverse 1/(x+iy) is inverted by multiplying numerator and denominator by the complex conjugate giving:
r=x²+y² x₁=x/r y₁=−y/r

To find the DFT of the inverse filter it remains to multiply this new set of 64 pair by the DFT of a impulse. Consider a sample sequence of 64 samples all of which are are zero except for the 33rd which has the value 1. In the above for this sample n=32. The DFT of this sample sequence, evaluated using the above, is comprised of 64 pair with real and imaginary of the form 1.0,0.0:−1.0,0.0 1.0,0.0: −1.0,0.0: etc to 64 pair. Some reflection shows that multiplying this set of 64 pair by the new set of 64 pair will simply change the sign of pairs 2,4 . . . 64 in the new set. When these sign changes are made and this set of 64 pair used in an IDFT of the form:

$${x}_{p} ( n ) = {\sum }_{R = 0}^{N - 1} {X}_{p} ( k ) {ⅇ}^{j ( 2 π / N ) kn}$$

the 64 output samples contain the samples 12 shown in FIG. 1C. The samples outside of the 6th from the peak are very small and can be removed leaving a total of 13 samples, 6 on either side of the centre sample. If this set of truncated samples is convolved with embedded samples 11 of FIG. 1B the impulse of FIG. 1D is the result.

### Transversal Filter Determination

The response dipulse 42 in FIG. 6B is filtered by the transversal filter 45 of FIG. 6C and the output after filtering is dipulse 46 of FIG. 6D, which should be as close as possible to a DIP9. Represent the Z transform of the response dipulse 42 by Y(z) and the Z transform of a DIP9 by DIP9(z). A filter C(z) is to be determined such that:
C(z)Y(z)=DIP9(z) C(z)=DIP9(z)/Y(z)

In the DFT domain the second equation above says that the DFT of the samples in C(z) can be determined by dividing the DFT of the samples in DIP9(z) by the DFT of the samples in Y(z). The first equation above says that C(z) is the desired transversal filter as it filters Y(z) to obtain DIP9(z). Thus the IDFT of the DFT of the samples in C(z) is the desired filter. This filter will be a transversal filter which can be truncated if the time functions in numerator and denominator are similiar. In this case DIP9(z) and Y(z) are similiar. In this case the transversal filter with 128 terms produced from the IDFT is truncated to 64 terms. This filter appears to be more than adequate to allow for the variations in Y(z) from DIP9(z).

FIG. 10B shows a typical response dipulse 82. The associated Power Spectrum 83 is shown in FIG. 10C. A DIP9 84 is shown in FIG. 10D and the associated Power Spectrum 85 in FIG. 10E. If the DFT of the samples in DIP9(z) is found and a pair represented by a+ib and the DFT of the samples in Y(z) found and represented by c+id then division of a pair i.e. a+ib/c+id yields a new pair x+iy where:
r=c₂+d² x=(ac+bd)/r y=(bc−ad)/r

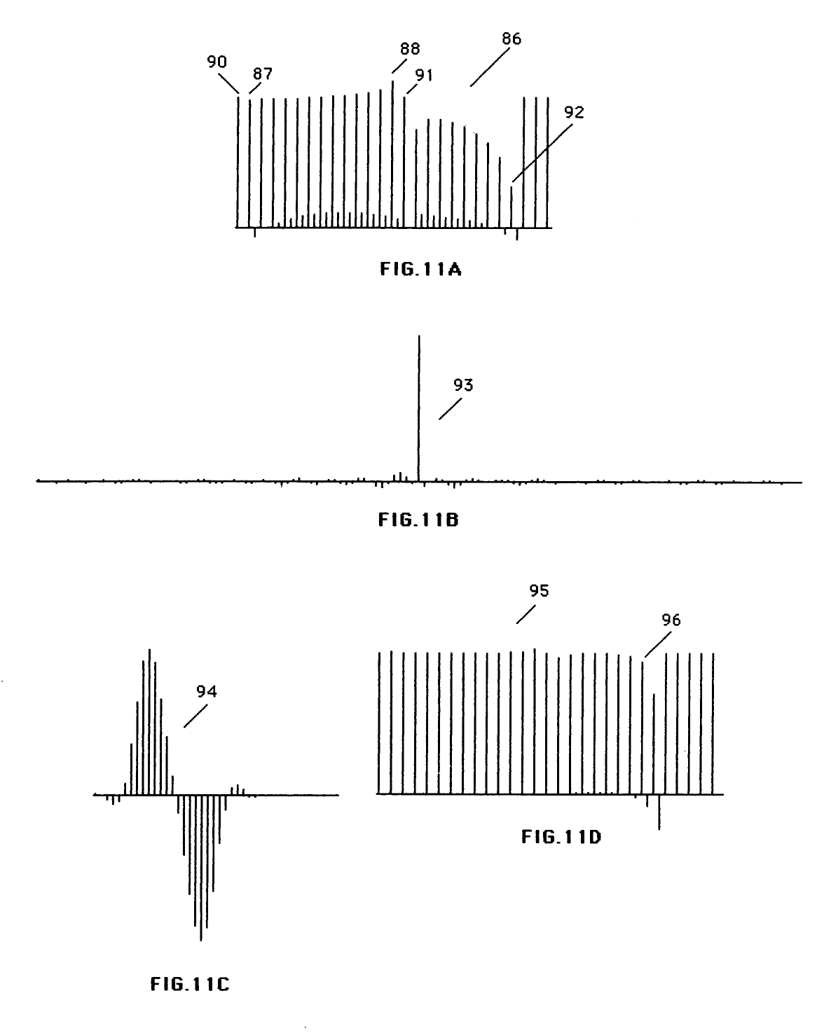

First note that if a+ib=c+id then x=1 and y=0. If all pair are 1,0 this is the DFT of an impulse. In this case no filtering is required as the DFT in numerator and denominator are the same so the time functions are the same. Conversely when the pairs differ from 1,0 as in FIG. 11A, the time functions associated with numerator and denominator are different. The filter is a impulse surrounded by terms which fall off and can be truncated.

The result of dividing these pairs is shown as 86 in FIG. 11A. Here for each pair the real part x is plotted first and the imaginary part y second. This division can be carried out from pair 2, 87 to pair 14,88. At pair 1 the frequency component 89 in DIP9,85 is 0 and in the response dipulse 83 is almost 0. At this point, 90 in FIG. 11A, a 1,0 is inserted which says, if components are small let them be equal. The same is done at pair 15,91 where the size of the component in the response dipulse is very small and difficult to measure. The components from 16 to 24, 92 can be calculated. From here to pair 65 the pair are set to 1,0, implying the components are equal. In the fft128 used here the pair in position 66 is the complex conjugate of the pair in position 64, 67 and 63 complex conjugates etc. Since the pairs from 1 to 65 have been determined the other pairs can be generated. If the IDFT of this DFT is taken the desired transversal filter can be displayed but not in a time position where truncation is easy and straight forward. The DFT of an impulse at time position 65 is of the form 1,0:−1,0:1,0:−1,0 etc. Multiplication of this DFT by the existing DFT amounts to changing the sign of the pair in positions 2,4,6 . . . 128. When the IDFT of this DFT is taken the transversal filter 93 shown in FIG. 11B is the result. This has 128 terms and if truncated to 64 terms and convolved with dipulse 82 of FIG. 10B, the result is dipulse 94 of FIG. 11C, which is very close to the ideal DIP9,84 of FIG. 10D. A transversal filter which when acting to filter the response dipulse produces an output dipulse which is a closer approximation to an ideal dipulse will hereafter be referred to as a response transversal filter.

FIG. 11D shows the result 95 of comparing the DFT of dipulse 94 of with the DFT of a DIP9.

The frequency pair are approaching 1:0:1:0 etc. which as described above, will be the case when numerator and denominator DFT are identical. There is some difference in the 23rd,96 and 24th pair. The 24th frequency component 97 is very small as is evident from the Power Spectrum 85 of FIG. 10E. It is important to note that the fft128 used for these calculations must handle a large variation in size of the frequency components. The vendor supplied fft128, which was for a 16 bit machine was modified to associate a power of 2 scale factor with each stored 16 bit number thus achieving 32 bit accuracy.

The transversal filter which is used to correct the response dipulse can also be used to correct the predistorted composing function. After a predistortion composing function has been established, using the method previously described, it can be trimmed using this transversal filter. The predistorted composing function when applied to the channel generates a response dipulse which when filtered by this transversal filter generates an ouput approaching an ideal dipulse. Since this is a linear system it follows that the output should remain the same if the transversal filter is applied to the predistorted composing function.

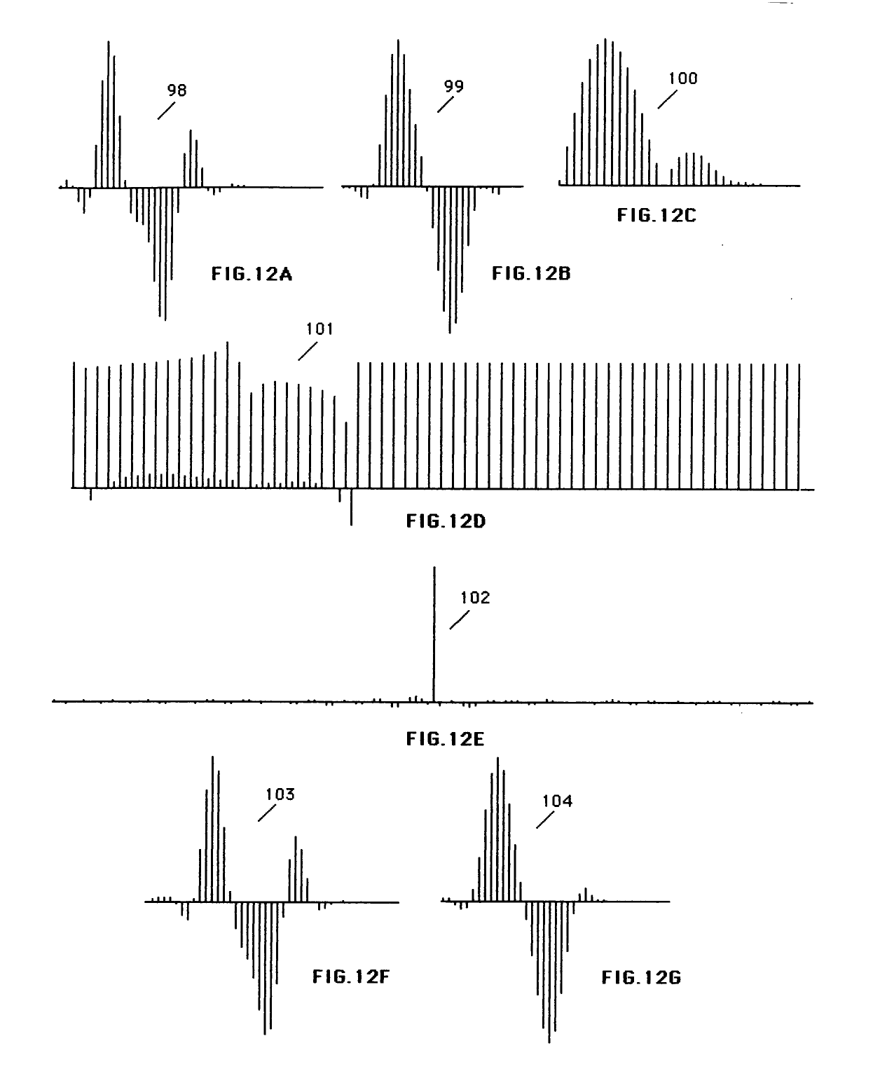

In the experimental system the composing function 98 shown in FIG. 12A was transmitted, the response dipulse was 99 shown in FIG. 12B. The power spectrum of the response dipulse is shown as 100 in FIG. 12C. The DFT of a DIP9 was divided by the DFT of wave 99 as above. The frequency pair which result are are shown in FIG. 12D as 101. As above in wave 101 the pair 1,15,24 and 25 to 65 are replaced by 1,0, the terms from 66 to 128 determined and terms 2,4 . . . 128 reversed in sign. The IDFT was then taken. The transversal filter 102 is the output from the IDFT. This transversal filter was applied to wave 98 of FIG. 12A, the output is the predistorted composing function 103 in FIG. 12F. This predistored composing function was then applied to the channel.

The output from the channel was wave 104 of FIG. 12G which is very close to an ideal dipulse. This is a very simple and powerful method of adjusting the predistorted composing function. A transversal filter determined from a response dipulse which when applied to the predistorted composing function generates a modified predistorted composing function which when applied to the channel generates a response dipulse which is closer to an ideal dipulse than the first response dipulse will hereafter be referred to as a composing function transversal filter.

### Modified Inverse Determination

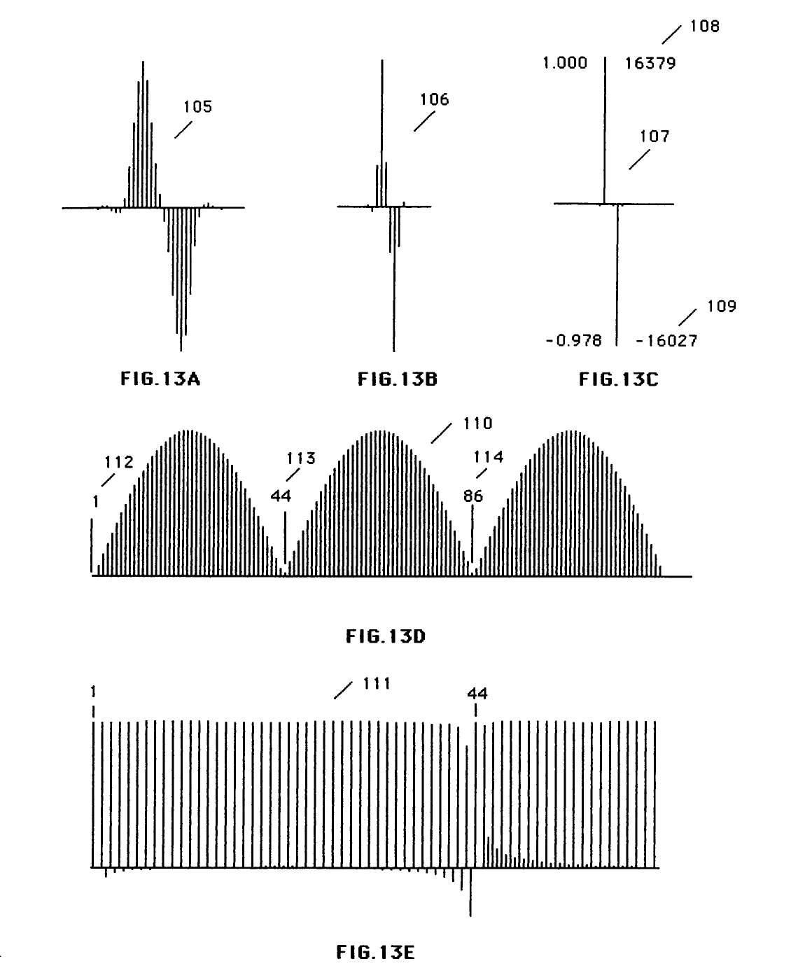

A response dipulse filtered by a response transversal filter is shown as 105 in FIG. 13A. It appears to be close to an ideal dipulse however if the embedded samples 106, shown in FIG. 13B are extracted and filtered by inverse filter 12 the output is the double impulse 107 shown in FIG. 13C. The peak integers 108, 109 output from an operating system are shown along with their relative size. The difference in size makes the quantization intervals different for positive and negative signals, reducing the number of levels which can be detected. This output is compared with the ideal response which is double impulse 18 of FIG. 1G with equal positive and negative peaks. A transversal filter is found which when applied to double impulse 107 of FIG. 13C will generate an ideal double impulse. This transversal filter is then convolved with inverse 12 to generate a modified inverse filter. The method used to find the transversal filter follows the above, as the time functions involved are very similiar.

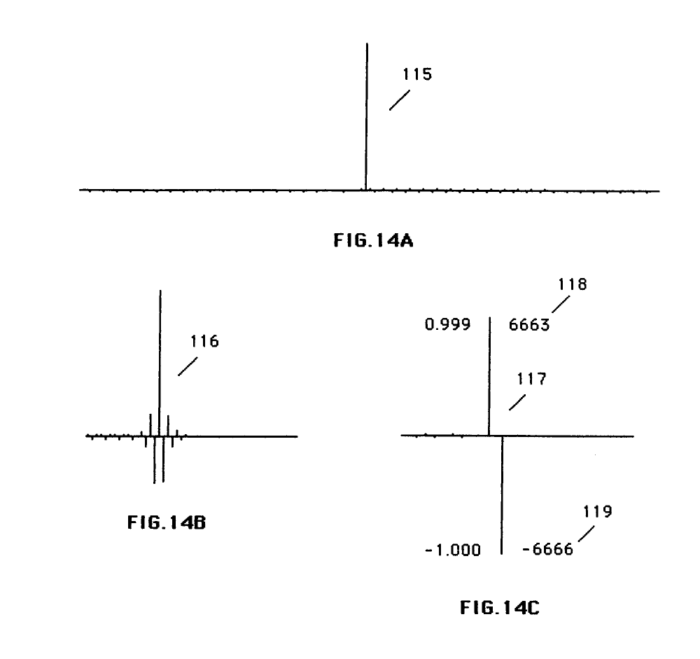

The power spectrum of an ideal double impulse is shown as 110 in FIG. 13D. The pairs which result when the DFT of an ideal double impulse is divided by the DFT of the double impulse 107 are shown as 111 in FIG. 13E. The values at positions 1,44,86 (112,113,114) are replaced by 1:0 and the sign of terms 2,4,6 . . . 128 reversed, as done above, and the IDFT taken. The result is the transversal filter shown as 115 in FIG. 14A. Modified inverse filter 116 in FIG. 14B results when this transversal filter of 128 terms in applied to the inverse filter 12, of 13 terms, and the result truncated to 34 terms. When this modifed inverse 116 is applied to the embedded samples 106 of FIG. 13B the double impulse shown in FIG. 14C as 117 is the result. The integer outputs from the operating system are shown as 118 and 119. Positive and negative peaks are identical to 1 part in 1000. This is a typical result.

The system operations described above can be summarized as follows. The predistorted composing function is determined. This composing function is transmitted over the channel and at the receiver sample synchronization is performed, a response dipulse is recorded. From this response dipulse a response transversal filter and a modified inverse are determined. A SKEW measurement is made on the response dipulse. This SKEW measurement is used to adjust the sampling point when the system is started up again so that the response transversal filter will operate on an appropriate set of samples. When the system is started again, to transmit modulation levels, sample synchronization is performed, followed by SKEW adjustment of the response dipulse. The received wave, which is the sum of scaled values of the response dipulse is then operated on by the response transversal filter to generate a filtered received wave which better approximates the sum of scaled values of ideal dipulses. The embedded samples from this filtered received wave are then operated on by the modified inverse filter to produce a first estimate of the transmitted modulation. This first estimate is corrected by generating a local wave, based in this first estimate, and differencing it with the received wave. From this difference wave, errors in the first estimate are located and corrected.

In this organization the response transversal filter and modified inverse are calculated prior to the transmission of a modulated wave. In practice this wave is made up of a set of packets each with a check sum. If each packet is preceded by a response dipulse and a fast fft128 is available, a response transversal filter and modified inverse filter can be determined for each packet. Thus it is guaranteed that the response transversal filter will act on an appropriate set of samples, as the scaled response dipulses making up the packet will be sampled at the same relative time positions as the response dipulse at the head of the packet. The SKEW dipulse will still be used between packets to make an initial adjustment of the sampling point. This organization may also be useful in systems where the transmission medium varies but not significantly during the duration of a packet.

The emphasis here has been on metallic lines. At this time it appears that the algorithms above can also be used in wireless systems which transmit data using embedded sample modulation. In the above referenced patent a method of predistortion equalization is described which probes the multipath radio channel to provide predistorted waveshapes for the I channel and Q channel which when used in the modulator at the transmitter will result in almost ideal dipulses in the I and Q baseband channels at the receiver. Thus two separate baseband waves can be generated as described above where one uses the predistorted wave for the I channel and the other the predistorted wave for the Q channel. The separate baseband waves at the receiver will have the same format as described above, i.e. the sum of scaled response dipulses, and each packet will be preceded by a response dipulse. The fading radio channel will change with time so each packet will likely have a radio channel probing pulse which will allow adjustment of the predistorted waves used for the I channel and Q channel or for small equalization adjustments at the receiver. Small channel variations, such as mechanical vibration of the antenna, might well be accommodated as each packet is decoded using a response transversal filter and modified inverse fitler appropriate at that time. Each baseband channel would be decoded as above, each would have its own response transversal filter, its own modified inverse, and its own difference wave. Since the channels are independent the bit rate would be double that of a single channel.

The above referenced results for the fading radio channel were obtained using Z transforms to represent the operations required, then using DFT and IDFT to perform the operations as was done above. The same approach can be used to find a method of predistortion equalization which probes a wireline passband channel to provide predistorted waveshapes for the I channel and Q channel which when used in the modulator at the transmitter will result in almost ideal dipulses in the I and Q baseband channels at the receiver.

There will be two baseband channels at the receiver and the transmiitted modulation in each will be recovered using the methods described and claimed here. The number of bits/second will be doubled over one baseband channel. This technique will be very useful in situations where a bandwidth constraint has been applied to the metallic line such as in existing telephone lines with associated filters transformers and capacitors. Where the copper itself is available, as has been assumed here, modified bit rates can be obtained by changing predistorted composing function, line length, half dipulse shape etc. It may be easier to obtain higher bit rates by going in this direciton than the passband direction, it remains to be seen.

In some applications not all the elements may be necessary. For example a first estimate of the transmitted modulation might be obtained without requiring either a response transversal filter or a modified inverse. The second independent claim below is for the use of a difference wave to detect the errors in the first estimate of the transmitted modulation. The subsequent dependent claims are intended to allow any combination of response transversal filter, or modified inverse with this error detection method.

What is claimed is:

1. A receiver to recover modulation transmitted by an embedded sample system where a received wave is the sum of scaled response dipulses, the scaling being determined by the modulation transmitted, said received wave being preceded by a response dipulse, said receiver comprising: a response transversal filter; a modified inverse filter; means for finding errors in a first estimate of the transmitted modulation comprised of: a difference wave and processing means for said difference wave to detect said errors, said difference wave being the difference between said received wave and a locally generated wave generated from said first estimate of the transmitted modulation, and wherein said receiver operates on said response dipulse to determine said response transversal filter and said modified inverse filter, and wherein said received wave is filtered by said response transversal filter to produce a first sample stream which is the sum of scaled dipulses which better approximates the sum of ideal dipulses, embedded samples from said first sample stream being extracted and fed to said modified inverse filter whose output after quantization is said first estimate of the transmitted modulation, and wherein said first estimate of the transmitted modulation is used to generate said locally generated wave which is differenced with said received wave to generate said difference wave which is processed by said processing means for said difference wave to detect said errors, whereby detected errors can be corrected by said receiver.

2. The receiver of claim 1 wherein processing means for said difference wave is selective sample addition.

3. The receiver of claim 1 wherein processing means for said difference wave is selective sample addition and correlation.

4. In a receiver to recover modulation transmitted by an embedded sample system means for finding errors in a first estimate of the transmitted modulation comprising: a difference wave, and processing means for said difference wave to detect said errors, said difference wave being the difference between a received wave and a locally generated wave generated from said first estimate of the transmitted modulation, and wherein said first estimate of the transmitted modulation is used to generate said locally generated wave and wherein said difference wave is generated as the difference between said received wave and said locally generated wave, said difference wave being processed by said processing means for said difference wave to detect said errors.

5. The receiver of claim 4 wherein processing means for said difference wave is selective sample addition.

6. The receiver of claim 4 wherein processing means for said difference wave is selective sample addition and correlation.

7. The receiver of claim 4, 5 or 6 optionally including a modified inverse filter.

8. Any receiver of claim 7 optionally including a response transversal filter.

9. For embedded sample systems a method for adjusting a predistorted composing function so that the response dipulse associated with an adjusted predistorted composing function better approximates an ideal dipulse when compared with the response dipulse associated with said predistorted composing function comprised of the steps: transmit said predistorted composing function to generate a response dipulse and determine from said response dipulse a composing function transversal filter, apply said composing function transversal filter to said predistorted composing function to generate said adjusted predistorted composing function.
